(19) United States
(12) Patent Application Publication
(10) Pub. No.: US 2007/0171927 A1
(43) Pub. Date: Jul. 26, 2007

(54) Multicast traffic forwarding in system supporting point-to-point (PPP) multi-link

(76) Inventors: Sung-Chan Paik, Suwon-si (KR); Sun-Gi Kim, Seoul (KR); Yong-Seok Park, Seongnam-si (KR)

Correspondence Address: Robert E. Bushnell, Suite 300, 1522 K Street, N.W., Washington, DC, 20005-1202, US

(21) Appl. No.: 11/657,608

(22) Filed: Jan. 25, 2007

(30) Foreign Application Priority Data
Jan. 26, 2006 (KR) 10-2006-0008586

(51) Int. Cl. H04L 12/56

(52) U.S. Cl. 370/402

(57) ABSTRACT

An apparatus and control method for multicast traffic forwarding in a system supporting Point-to-Point Protocol (PPP) multi-link includes: a memory adapted to store a received frame and a buffer handler having meta data information; and a network processor adapted to: store the frame received from an external network interface card in the memory; store the buffer handler indicating the frame and as many buffer handlers as either frame copies for multicasting or fragments for multi-linking; check the buffer handler stored in the memory and then to copy and transmit the corresponding frame stored in the memory via a corresponding port upon transmitting the frame to an external network interface card; and delete corresponding buffer handlers after transmitting the frame to the external network interface card, thereby managing forwarding of the frame.

### CLAIM OF PRIORITY

This application makes reference to, incorporates the same herein, and claims all benefits accruing under 35 U.S.C. § 19 from an application for MULTICAST FOR WARDING APPARATUS AND CONTROL METHOD IN SYSTEM FOR USING PPP MULTI-LINK earlier filed in the Korean Intellectual Property Office on the 26 Jan. 2006 and there duly assigned Serial No. 10-2006-0008586.

### BACKGROUND OF THE INVENTION

1. Field of the Invention

The present invention relates to an apparatus and control method for multicast traffic forwarding in a system supporting Point-to-Point Protocol (PPP) multi-link.

2. Description of the Related Art

In general, Point-to-Point Protocol (PPP) multi-link, as defined in Request for Comments (RFC) 1990, is a protocol that combines several physical lines logically into a single logical PPP connection and uses the combined bandwidth of the physical lines.

Equipment supporting PPP multi-link determine a frame fragmentation size for using a multi-link protocol in order to transmit the frame through several physical lines. Transmitting equipment fragments one frame, allocates a sequence number to each fragmented frame using a round-robin method, and transmits the fragmented frames having a negotiated frame size through the connected physical lines. Receiving equipment reassembles the fragmented frames using their sequence numbers, and forwards the reassembled frames again or transmits them to a specific application.

However, when dealing with multicast frames, since a copied frame must be fragmented again into several frames, processing overhead is high.

### SUMMARY OF THE INVENTION

It is an object of the present invention to provide an apparatus and control method for multicast traffic forwarding in a system supporting Point-to-Point Protocol (PPP) multi-link, the apparatus and control method copying/deleting only meta data of a packet stored in a buffer of a memory, performing a packet fragmentation function for multi-linking and a packet copy function for multicast traffic processing in a PPP multi-link, to thereby improve performance of a forwarding engine.

One aspect of the present invention provides a multicast traffic forwarding apparatus in a system supporting Point-to-Point Protocol (PPP) multi-link, the apparatus including: a memory adapted to store a received frame and a buffer handler having meta data information; and a network processor adapted to: store the frame received from an external network interface card in the memory; store the buffer handler indicating the frame and as many buffer handlers as either frame copies for multicasting or fragments for multi-linking; check the buffer handler stored in the memory and then to copy and transmit the corresponding frame stored in the memory via a corresponding port upon transmitting the frame to an external network interface card; and delete corresponding buffer handlers after transmitting the frame to the external network interface card, thereby managing forwarding of the frame.

The network processor preferably includes: a reception processing unit adapted to store the received frame and the buffer handler in the memory upon the frame being received from the external network interface card; a PPP frame forwarding unit adapted to transmit an output port list, after checking a data processing method of the frame received from the reception processing unit; a packet copying unit adapted to generate as many buffer handlers as output ports corresponding to the output port list and to store the generated buffer handlers in the memory upon receiving the output port list of the frame from the PPP frame forwarding unit; a multi-link frame fragmentation unit adapted to determine a fragmentation number of the frame, to generate as many buffer handlers as the fragmentation number, and to store the generated buffer handlers in the memory upon receiving a frame header encapsulated in a PPP header from either the PPP frame forwarding unit or the packet copying unit; and a transmission processing unit adapted to transmit the corresponding frame to the external network interface card after checking the buffer handler stored in the memory.

Each buffer handler preferably includes a main buffer handler including meta data information and preferably indicating a buffer address at which the frame is stored, and at least one sub-buffer handler indicating the main buffer handler.

The memory is preferably adapted to support PPP multi-link and preferably includes at least one first buffer handler pool used for a unicast method, and at least one second buffer handler pool used for both multi-linking and a multicast method.

The PPP forwarding unit preferably includes a database having at least one Internet Protocol (IP) address and output port list of the IP address stored therein, the PPP forwarding unit preferably adapted to recognize a data processing method of the frame using a destination IP address stored in the database.

The PPP frame forwarding unit is preferably adapted to access the database and to determine whether the data processing method of the frame is a unicast method or a multicast method using the destination IP address. The PPP frame forwarding unit is preferably adapted to access the database and to determine whether an output port of the destination IP address is a general PPP port or a PPP multi-link port. The PPP frame forwarding unit is preferably adapted to encapsulate a header of the frame in a PPP header and to transmit the header to the transmission processing unit upon a determination that the data processing method of the frame is the unicast method and that an output port of the destination IP address is a general PPP port. The PPP frame forwarding unit is preferably adapted to encapsulate a header of the frame in a PPP header and to transmit the header to the multi-link frame fragmentation unit upon a determination that the data processing method of the frame is the unicast method and that an output port of the destination IP address is a multi-link port. The PPP frame forwarding unit is preferably adapted to transmit a header of the frame to the packet copying unit upon a determination that the data processing method of the frame is the multicast method.

The packet copying unit is preferably adapted to encapsulate and transmit a PPP header to the multi-link frame fragmentation unit upon a determination that an output port to be copied is a PPP multi-link interface. The packet copying unit is preferably adapted to encapsulate and transmit the PPP header to the transmission processing unit upon a determination that the output port to be copied is a general PPP interface.

The buffer handlers stored in the memory by the packet copying unit preferably include sub-buffer handlers including meta data information indicating the buffer handler stored in the memory by the reception processing unit.

The packet copying unit is preferably adapted to update the number of buffer handlers in the buffer handler stored by the reception processing unit with the number of generated buffer handlers.

The buffer handlers stored in the memory by the multi-link frame fragmentation unit preferably include sub-buffer handlers including meta data information indicating the buffer handler stored in the memory by the reception processing unit.

The multi-link frame fragmentation unit is preferably adapted to update the number of buffer handlers in the buffer handler stored by the reception processing unit with the number of generated buffer handlers.

The transmission processing unit is preferably adapted to delete corresponding buffer handlers stored in the memory after checking the memory and transmitting the frame to the external network interface card.

Another aspect of the present invention provides a multicast traffic forwarding control method in a system supporting Point-to-Point Protocol (PPP) multi-link, the method including: storing a received frame and a main buffer handler upon the frame being received from an external network interface card; determining a data processing method of the frame; generating and storing as many sub-buffer handlers of the frame as output ports for the multicasting upon a determination that the data processing method of the frame is a multicast method; updating the number of sub-buffer handlers in the main buffer handler with the number of sub-buffer handlers; determining whether or not a multi-link port is included in an output port list; determining a fragmentation number of the frame, and generating and storing as many sub-buffer handlers as the fragmentation number upon a determination that a multi-link port is included in the output port list; updating the number of sub-buffer handlers in the main buffer handler with the fragmentation number; and transmitting the frame to an external network interface card and deleting the sub-buffer handlers.

The method preferably further including, upon a determination that the data processing method of the frame is a unicast method: determining whether or not a multi-link port is included in an output port list; determining a fragmentation number of the frame, and generating and storing as many sub-buffer handlers as the fragmentation number upon a determination that a multi-link port is included in the output port list; updating the number of sub-buffer handlers in the main buffer handler with the fragmentation number; and transmitting the frame to an external network interface card and deleting the sub-buffer handlers.

The method preferably further including, upon a determination that a multi-link port is not included in the output port list: transmitting the frame to an external network card; and deleting the stored main buffer handler upon checking the number of sub-buffer handlers and determining that there are no sub-buffer handlers.

The method preferably further including, upon a determination that a multi-link port is not included in the output port list: transmitting the frame to an external network card; and deleting the stored main buffer handler upon checking the number of sub-buffer handlers and determining that there are no sub-buffer handlers.

The main buffer handler preferably includes meta data information including the number of sub-buffer handlers and indicates a buffer address at which the frame is stored.

The sub-buffer handlers preferably indicate the main buffer handler.

Determining a data processing method of the frame preferably includes accessing a database including at least one Internet Protocol (IP) address and an output port list of the IP address and determining a data processing method of the frame using a destination IP address in the database.

Determining a data processing method of the frame preferably includes accessing a database and determining whether a data processing method of the frame is a unicast method or multicast method using an output port list of a destination Internet Protocol (IP) address.

Determining a data processing method of the frame preferably includes accessing the database and determining whether an output port of the destination IP address is a general PPP port or a PPP multi-link port.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of an apparatus for multicast traffic forwarding in a system supporting Point-to-Point Protocol (PPP) multi-link according to an exemplary embodiment of the present invention;

FIG. 2 is a view of a multicast transmission of a frame using a multi-link of the multicast traffic forwarding apparatus in a system supporting PPP multi-link according to FIG. 1;

FIG. 3A is a view of sub-buffer handlers generated in a memory by a packet copying unit in order to perform multicasting in the multicast traffic forwarding apparatus of a system supporting PPP multi-link according to FIG. 1;

FIG. 3B is a view of sub-buffer handlers generated in the memory by the packet copying unit and a multi-link frame fragmentation unit in order to simultaneously perform multicasting and multi-linking in the multicast traffic forwarding apparatus of a system supporting PPP multi-link according to FIG. 1;

FIG. 4 is a view of a state of the memory in the multicast traffic forwarding apparatus of a system supporting PPP multi-link according to FIG. 1 after the multi-link frame fragmentation unit has processed sub-buffer handlers; and

FIGS. 5A to 5C form a flowchart of a control method for multicast traffic forwarding in a system supporting PPP multi-link according to exemplary embodiments of the present invention.

### DETAILED DESCRIPTION OF THE INVENTION

Hereinafter, exemplary embodiments of the present invention are described in detail with reference to the accompanying drawings. Matters related to the present invention which are well known in the art have been omitted from the following description for the sake of clarity and conciseness.

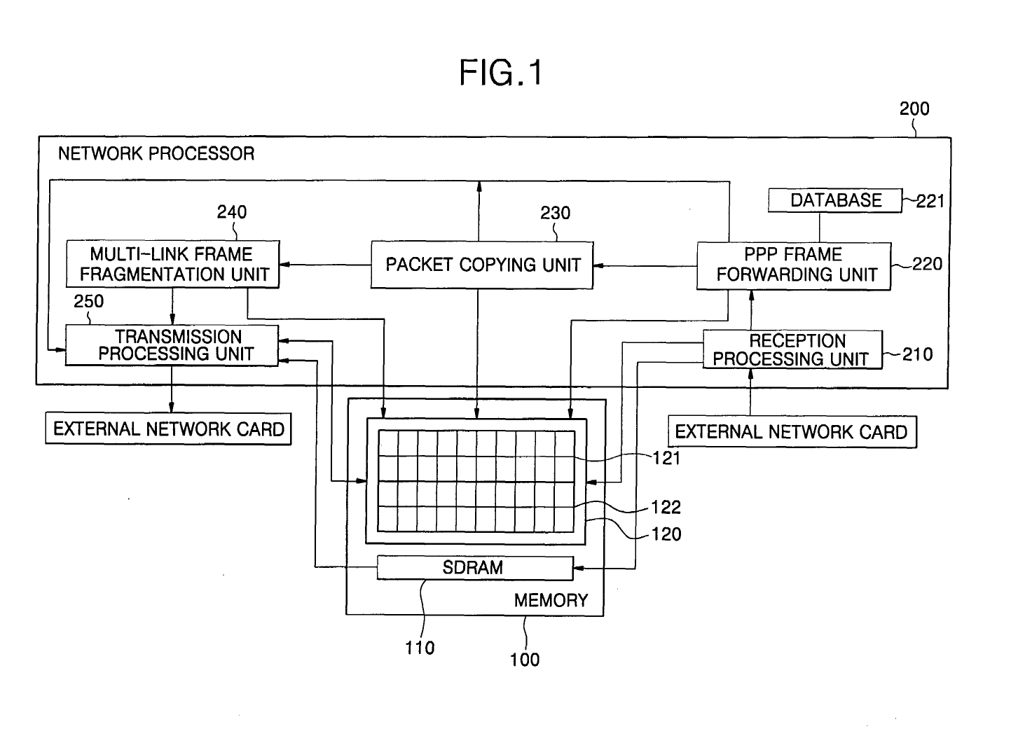

FIG. 1 is a block diagram of an apparatus for multicast traffic forwarding in a system supporting Point-to-Point Protocol (PPP) multi-link according to an exemplary embodiment of the present invention. The multicast traffic forwarding apparatus in a system supporting PPP multi-link according to the present invention includes a memory 100 and a network processor 200.

A frame received from an external network interface card and a buffer handler having meta data information are stored in the memory 100. The memory 100 includes a Synchronous Dynamic Random Access Memory (SDRAM) 110 having the frame stored therein, at least one first buffer handler pool 121 of a Static Random Access Memory (SRAM) 120 used for a unicast method, and at least one second buffer handler pool 122 of the SRAM 120 used for multi-linking and a multicast method.

The network processor 200 stores the frame received from the external network interface card in the memory 100, stores a buffer handler indicating the frame and as many buffer handlers as frame copies/fragments for multicasting or multi-linking, and deletes the buffer handlers after transmitting the frame to an external network interface card, thereby managing forwarding of the frame. In addition, the network processor 200 includes a reception processing unit 210, a PPP frame forwarding unit 220, a packet copying unit 230, a multi-link frame fragmentation unit 240, and a transmission processing unit 250.

When receiving the frame from the external network interface card, the reception processing unit 210 of the network processor 200 stores the received frame and the buffer handler in the memory 100.

The PPP frame forwarding unit 220 of the network processor 200 checks the data processing method of the frame received through the reception processing unit 210, and then transmits an output port list. The PPP frame forwarding unit 220 includes a database 221 in which at least one Internet Protocol (IP) address and output port list of the IP address are stored, in order to recognize the data processing method (multicast or unicast) of the frame using a destination IP address.

In addition, the PPP frame forwarding unit 220 accesses the database 221 and determines whether the data processing method of the frame is the unicast method or the multicast method and whether an output port of the output port list is a general PPP port or a PPP multi-link port.

The PPP frame forwarding unit 220 then encapsulates the header of the frame in a PPP header and transmits it to the transmission processing unit 250 when the frame transmission method is the unicast method and the output port is a general PPP port, to the multi-link frame fragmentation unit 240 when the frame transmission method is the unitcast method and the output port is a PPP multi-link port, and to the packet copying unit 230 when the frame transmission method is the multicast method.

When receiving the frame header encapsulated in the PPP header and the output port list of the frame from the PPP frame forwarding unit 220, the packet copying unit 230 of the network processor 200 generates as many buffer handlers as output ports corresponding to the output port list and stores the generated buffer handlers in the memory 100. The packet copying unit 230 transmits the frame header encapsulated in the PPP header to the multi-link frame fragmentation unit 240 when a PPP multi-link interface exists among the output ports to be copied, and transmits the frame header encapsulated in the PPP header to the transmission processing unit 250 when the output ports to be copied are general PPP interfaces.

The buffer handlers stored in the memory 100 by the packet copying unit 230 are sub-buffer handlers including meta data information indicating the buffer handler stored in the memory 100 by the reception processing unit 210. The packet copying unit 230 updates the number of buffer handlers in the buffer handler stored by the reception processing unit 210 with the number of generated buffer handlers.

When receiving a frame header encapsulated in a PPP header from the PPP frame forwarding unit 220 or the packet copying unit 230, the multi-link frame fragmentation unit 240 of the network processor 200 determines the fragmentation number of the frame, generates as many buffer handlers as the fragmentation number, and stores the generated buffer handlers in the memory 100. The buffer handlers stored in the memory 100 by the multi-link frame fragmentation unit 240 are sub-buffer handlers including meta data information indicating the buffer handler stored in the memory 100 by the reception processing unit 210. The packet copying unit 230 updates the number of buffer handlers in the buffer handler stored by the reception processing unit 210 with the number of generated buffer handlers.

The transmission processing unit 250 of the network processor 200 checks the buffer handler stored in the memory 100, and then transmits the frame corresponding to the buffer handler to the external network interface card. The transmission processing unit 250 checks the memory 100, transmits the frame to the external network interface card, and then deletes the corresponding buffer handlers.

The buffer handlers are a main buffer handler having meta data information including the number of sub-buffer handlers and indicating an address of a buffer storing the frame, and the sub-buffer handlers indicating the main buffer handler.

A description of the general functions and detailed operations of each component mentioned above has been omitted. Instead, the operations of each component in the embodiments of the present invention are described below.

First, a case where a frame received from an external network interface card is transmitted using both the multicast method and multi-link is described below. A database looked up by the PPP frame forwarding unit 220 is as shown in Table 1.

TABLE 1

| | | |
|---|---|---|
| IP address | Output port | Others |

| | |
|---|---|
| 225.0.0.5 | bn − 1, P1, P2 and P3 |
| . . . | . . . |
| 225.0.0.3 | P1, P2 and P3 |
| 225.0.0.2 | P1 |
| 225.0.0.1 | bn − 1, |

In Table 1, “bn” denotes a PPP multi-link port, and “P” denotes a general PPP port.

When receiving a frame from the external network interface card, the reception processing unit 210 stores the received frame in the SDRAM 110 and a main buffer handler indicating a buffer address of the frame in the second handler pool 122 of the SRAM 120. It is assumed that a destination IP address of the frame received through the reception processing unit 210 is “225. 0. 0. 5”.

In addition, the number of sub-buffer handlers, among meta data information of the main buffer handler stored in the second handler pool 122 of the SRAM 120, is zero.

Subsequently, the PPP frame forwarding unit 220 compares the IP address (225. 0. 0. 5) of the frame received through the reception processing unit 210 with an IP address (225. 0. 0. 5) stored in the database, and obtains an output port list (bn−1, P1, P2 and P3).

The PPP frame forwarding unit 220 recognizes that the frame is multicast and a PPP multi-link port is needed.

The PPP frame forwarding unit 220 then encapsulates the header of the frame in a PPP header, and transmits the output port list (bn−1, P1, P2 and P3) of the frame to the packet copying unit 230.

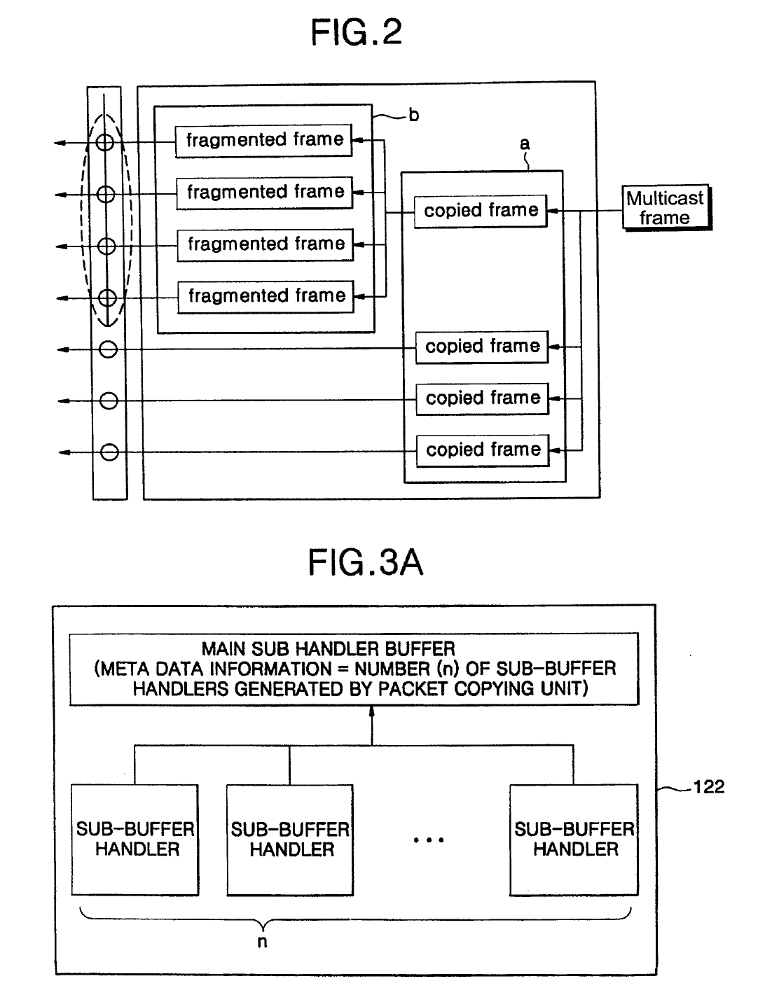

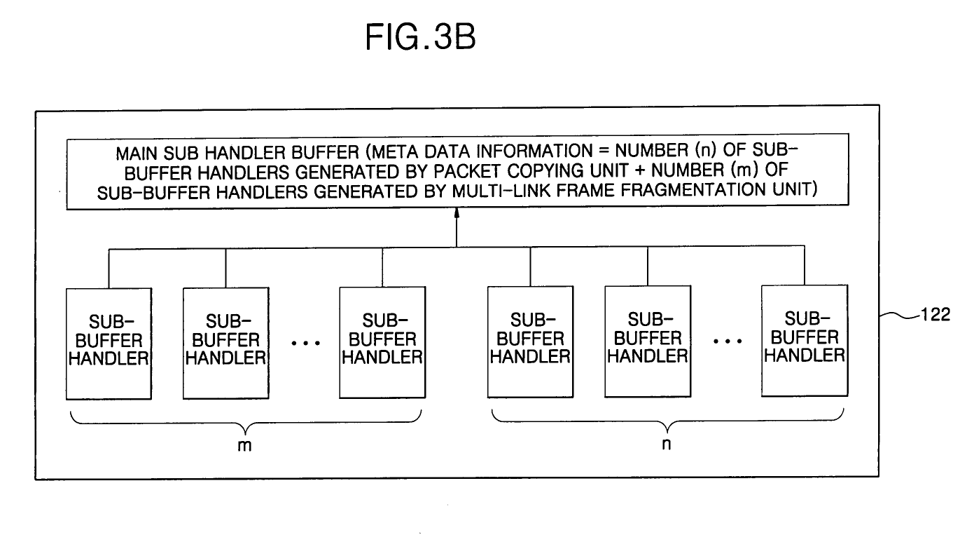

After checking the output port list (bn−1, P1, P2 and P3) received from the PPP frame forwarding unit 220, the packet copying unit 230 generates four sub-buffer handlers (a) as illustrated in FIG. 2, stores them in the second handler pool 122 of the SRAM 120 as illustrated in FIG. 3A, and updates the number of sub-buffer handlers among meta data information of the main buffer handler to four. The sub-buffer handlers (a) indicate the main buffer handler stored in the second handler pool 122 of the SRAM 120.

Subsequently, the packet copying unit 230 separately transmits the frame header encapsulated in the PPP header to the transmission processing unit 250 and the multi-link frame fragmentation unit 240.

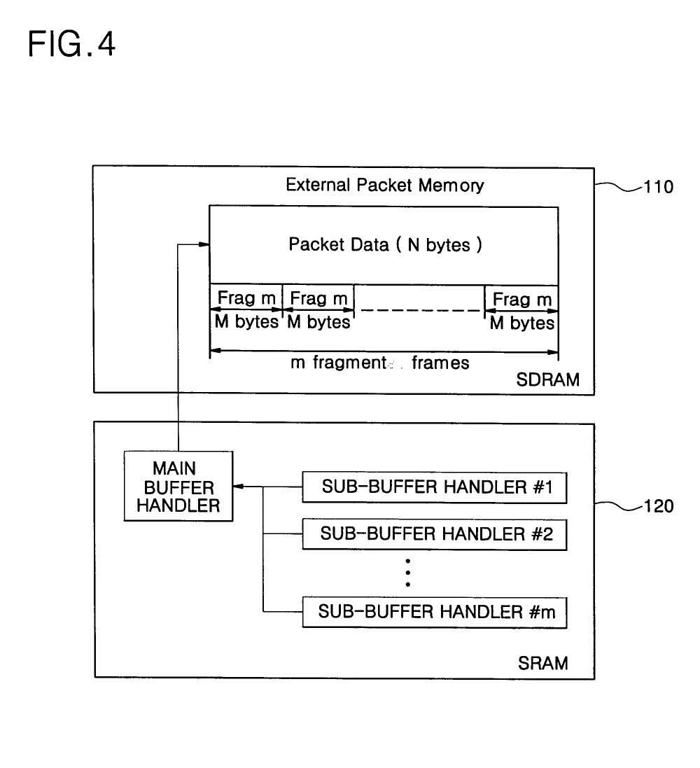

When receiving the frame header encapsulated in the PPP header through the packet copying unit 230, the multi-link frame fragmentation unit 240 determines the fragmentation number of the frame as illustrated in FIG. 4, generates as many sub-buffer handlers (b) as the fragmentation number as illustrated in FIG. 2, stores the generated sub-buffer handlers (b) in the second handler pool 122 of the SRAM 120 as illustrated in FIG. 3B, and updates the number of sub-buffer handlers among meta data information of the main buffer handler by six. FIG. 2 is a view of an exemplary embodiment of multicasting and multi-linking, showing only four sub-buffer handlers (b) and the frame transmitted through four multiports.

As illustrated in FIG. 3B, one main buffer handler and ten sub-buffer handlers are stored in the second handler pool 122 of the SRAM 120.

Subsequently, the multi-link frame fragmentation unit 240 transmits the frame header encapsulated in the PPP header to the transmission processing unit 250.

Then, the transmission processing unit 250 checks meta data information of the main buffer handler stored in the second handler pool 122 of the SRAM 120. When a sub-buffer handler exists, the transmission processing unit 250 transmits the frame stored in the SDRAM 110 to an external network interface card and deletes the corresponding sub-buffer handler from the second handler pool 122 of the SRAM 120.

In addition, as the sub-buffer handler is deleted from the second handler pool 122 of the SRAM 120, the number of sub-buffer handlers among meta data information of the main buffer is reduced by one.

When the above-described process is repeated and thus the number of sub-buffer handlers among meta data information of the main buffer becomes zero, the main buffer handler stored in the second handler pool 122 of the SRAM 120 is also deleted and transmission of all frames to be currently transmitted is terminated.

Next, a case where a frame received from an external network interface card is transmitted using only the multicast method is described below.

When receiving a frame from the external network interface card, the reception processing unit 210 stores the received frame in the SDRAM 110 and a main buffer handler indicating an buffer address of the frame in the second handler pool 122 of the SRAM 120. It is assumed that a destination IP address of the frame received through the reception processing unit 210 is “225. 0. 0. 3”.

In addition, the number of sub-buffer handlers among meta data information of the main buffer handler stored in the second handler pool 122 of the SRAM 120 is zero.

Subsequently, the PPP frame forwarding unit 220 compares the IP address (225. 0. 0. 3) of the frame received through the reception processing unit 210 with an IP address (225. 0. 0. 3) stored in the database, and obtains an output port list (P1, P2 and P3).

Therefore, the PPP frame forwarding unit 220 recognizes that the frame is multicast and there is no PPP multi-link port.

The PPP frame forwarding unit 220 then encapsulates the header of the frame in a PPP header, and transmits the output port list (P1, P2 and P3) of the frame to the packet copying unit 230.

Then, after checking the output port list (P1, P2 and P3) received from the PPP frame forwarding unit 220, the packet copying unit 230 generates three sub-buffer handlers, stores the sub-buffer handlers in the second handler pool 122 of the SRAM 120, and updates the number of sub-buffer handlers among meta data information of the main buffer handler to three. The sub-buffer handlers indicate the main buffer handler stored in the second handler pool 122 of the SRAM 120.

Subsequently, the packet copying unit 230 transmits the frame header encapsulated in the PPP header to the transmission processing unit 250.

Therefore, one main handler and three sub-buffer handlers are stored in the second handler pool 122 of the SRAM 120.

Then, the transmission processing unit 250 checks the main buffer handler stored in the second handler pool 122 of the SRAM 120.

When a sub-buffer handler exists in meta data information of the main buffer handler, the transmission processing unit 250 transmits the frame stored in the SDRAM 110 to an external network interface card and deletes the corresponding sub-buffer handler from the second handler pool 122 of the SRAM 120.

In addition, as the sub-buffer handler is deleted from the second handler pool 122 of the SRAM 120, the number of sub-buffer handlers among meta data information of the main buffer is reduced by one.

When the above-described process is repeated and thus the number of sub-buffer handlers among meta data information of the main buffer becomes zero, the main buffer handler stored in the second handler pool 122 of the SRAM 120 is also deleted and transmission of all frames is terminated.

Next, a case where a frame received from an external network interface card is transmitted using only the unicast method is described below.

When receiving a frame from the external network interface card, the reception processing unit 210 stores the received frame in the SDRAM 110 and a main buffer handler in the first handler pool 121 of the SRAM 120. It is assumed that a destination IP address of the frame received through the reception processing unit 210 is “225. 0. 0. 2”.

In addition, the number of sub-buffer handlers among meta data information of the main buffer handler stored in the first handler pool 121 of the SRAM 120 is zero.

Subsequently, the PPP frame forwarding unit 220 compares the IP address (225. 0. 0. 2) of the frame received through the reception processing unit 210 with an IP address (225. 0. 0. 2) stored in the database, and obtains an output port list (P1).

Therefore, the PPP frame forwarding unit 220 recognizes that the frame is unicast and a PPP multi-link port is not needed.

The PPP frame forwarding unit 220 then encapsulates the header of the frame in a PPP header, and transmits the output port list (P1) of the frame to the transmission processing unit 250.

One main buffer handler and one sub-buffer handler are stored in the first handler pool 121 of the SRAM 120.

Subsequently, the transmission processing unit 250 checks meta data information of the main buffer handler stored in the first handler pool 121 of the SRAM 120. When a sub-buffer handler exists, the transmission processing unit 250 transmits the frame stored in the SDRAM 110 to an external network interface card and deletes the corresponding sub-buffer handler from the first handler pool 121 of the SRAM 120.

In addition, as the sub-buffer handler is deleted from the first handler pool 121 of the SRAM 120, the number of sub-buffer handlers among meta data information of the main buffer is reduced by one.

When the above-described process is repeated and thus the number of sub-buffer handlers among meta data information of the main buffer becomes zero, the main buffer handler stored in the first handler pool 121 of the SRAM 120 is also deleted and transmission of all frames is terminated.

Next, a case where a frame received from an external network interface card is transmitted using the unicast method and the multicast method is described below.

When receiving a frame from the external network interface card, the reception processing unit 210 stores the received frame in the SDRAM 110 and a main buffer handler in the first handler pool 121 of the SRAM 120. It is assumed that a destination IP address of the frame received through the reception processing unit 210 is “225. 0. 0. 1”.

In addition, the number of sub-buffer handlers among meta data information of the main buffer handler stored in the first handler pool 121 of the SRAM 120 is zero.

Subsequently, the PPP frame forwarding unit 220 compares the IP address (225. 0. 0. 1) of the frame received through the reception processing unit 210 with an IP address (225. 0. 0. 1) stored in the database, and obtains an output port list (bn−1).

Therefore, the PPP frame forwarding unit 220 recognizes that the frame is unicast and a PPP multi-link port is not needed.

The PPP frame forwarding unit 220 then encapsulates the header of the frame in a PPP header, and transmits the output port list (bn−1) of the frame to the multi-link frame fragmentation unit 240.

When receiving the frame header encapsulated in the PPP header and the output port list (bn−1) from the PPP frame forwarding unit 220, the multi-link frame fragmentation unit 240 determines the fragmentation number (six) of the frame, generates as many sub-buffer handlers as the fragmentation number (six), stores the sub-buffer handlers in the first handler pool 121 and the second handler pool 122 of the SRAM 120, and updates the number of sub-buffer handlers among meta data information of the main buffer handler by the number (six) of the generated sub-buffer handlers.

Therefore, one main buffer handler is stored in the first handler pool 121 of the SRAM 120, and six sub-buffer handlers are stored in the second handler pool 122.

Then, the multi-link frame fragmentation unit 240 transmits the frame header encapsulated in the PPP header and the output port list (bn−1) of the frame to the transmission processing unit 250.

Subsequently, the transmission processing unit 250 checks meta data information of the main buffer handler stored in the first handler pool 121 of the SRAM 120.

When a sub-buffer handler exists according to the meta data information of the main buffer handler, the transmission processing unit 250 transmits the frame stored in the SDRAM 110 to an external network interface card and deletes the corresponding sub-buffer handler from the second handler pool 122 of the SRAM 120.

In addition, as the sub-buffer handler is deleted from the second handler pool 122 of the SRAM 120, the number of sub-buffer handlers among meta data information of the main buffer is reduced by one.

When the above-described process is repeated and thus the number of sub-buffer handlers among meta data information of the main buffer becomes zero, the main buffer handler stored in the first handler pool 121 of the SRAM 120 is also deleted and transmission of all frames is terminated.

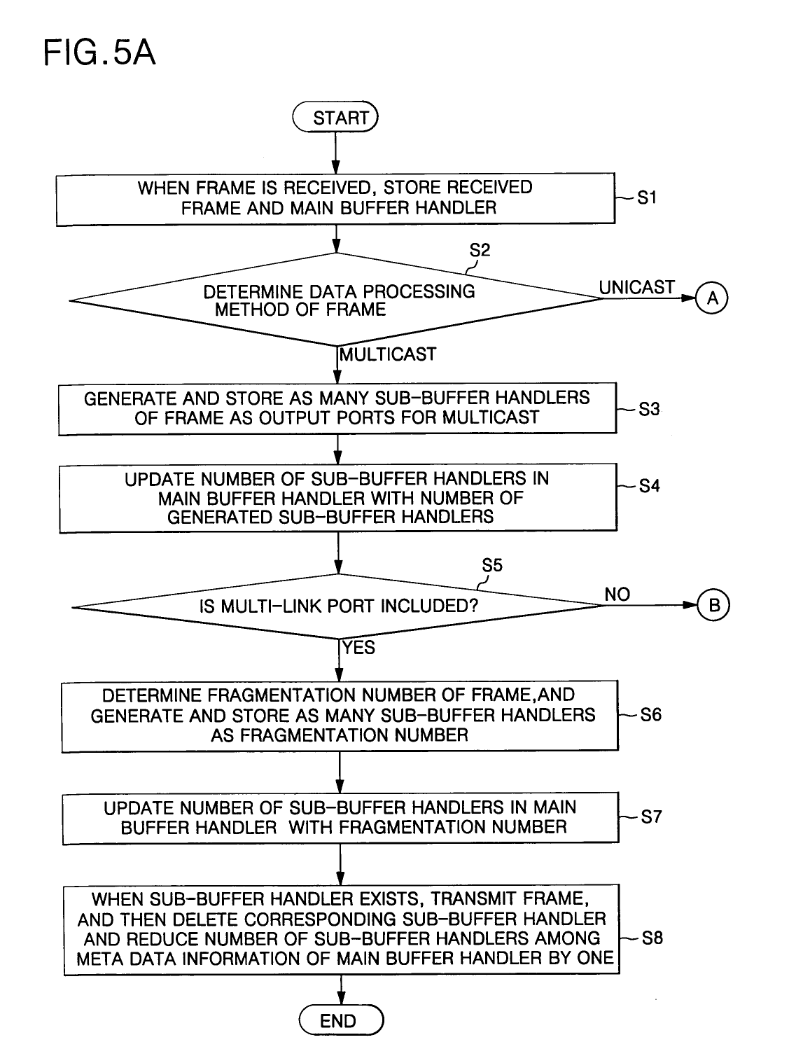

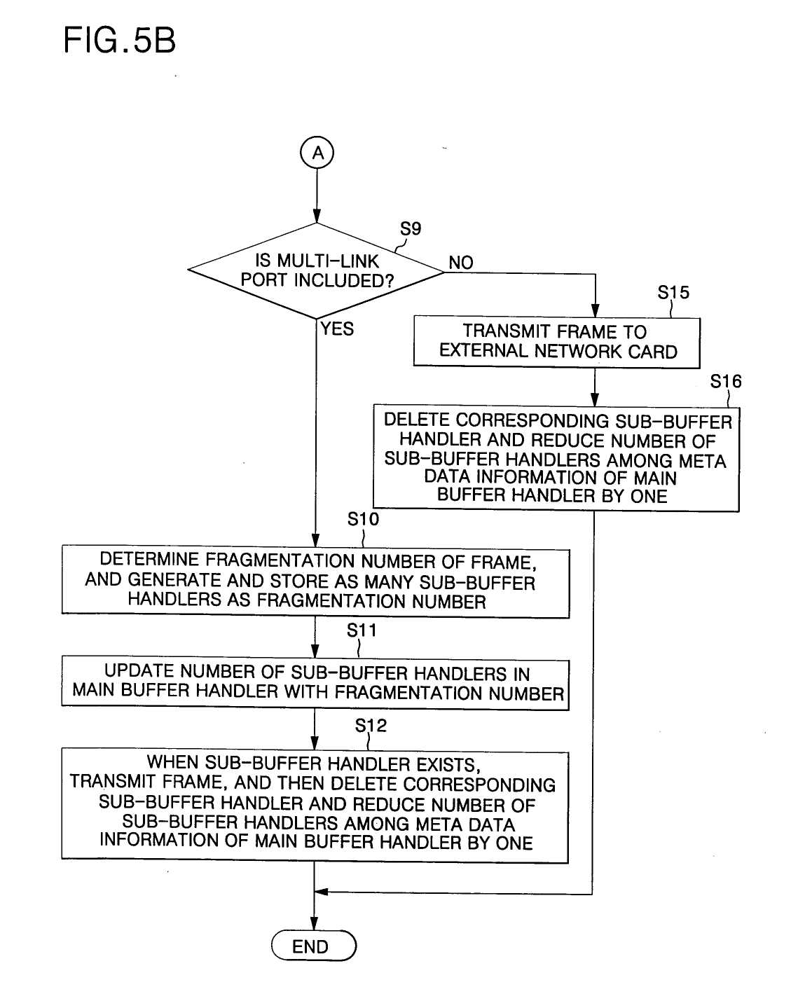

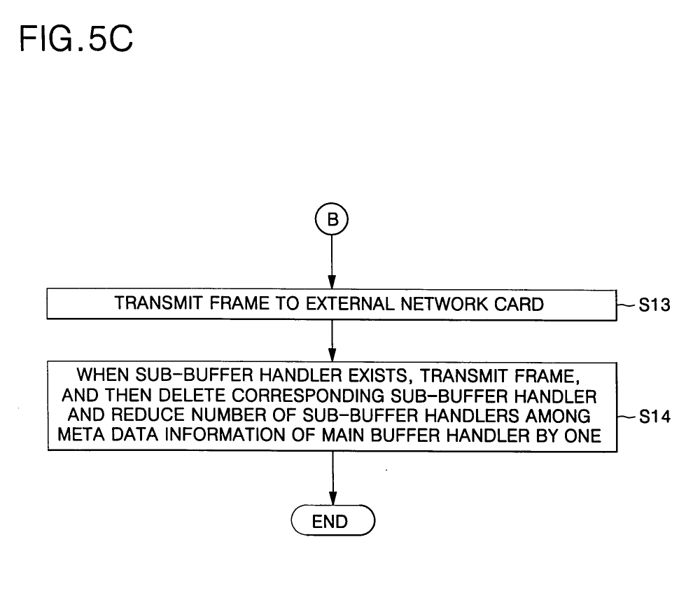

A control method for multicast traffic forwarding in a system supporting PPP multi-link according to an exemplary embodiment of the present invention is described below with reference to FIGS. 5A to 5C, the control method responding to a video-on-demand service request.

First, in step S1, when a frame is received from an external network interface card, the received frame and a main buffer handler are stored. The main buffer handler includes meta data information including the number of sub-buffer handlers, and indicates a buffer address at which the frame is stored.

In step S2, the data processing method of the frame is determined by accessing a database including at least one IP address, and an output port list of the IP address, and using a destination IP address. More specifically, the database is accessed and a determination is made, using the output port list of the destination IP address, as to whether the data processing method of the frame is the unicast method or the multicast method and whether an output port of the output port list information is a general PPP port or a PPP multi-link port.

When it has been determined that the data processing method of the frame is the multicast method in step S2, as many sub-buffer handlers as output ports for multicasting are generated and stored in step S3. The sub-buffer handlers indicate the main buffer handler.

Subsequently, in step S4, the number of sub-buffer handlers is updated in the main buffer handler.

In step S5, a determination is made as to whether or not a multi-link port is included in the output port list.

When it has been determined that a multi-link port is included in the output port list (YES) in step S5, the fragmentation number of the frame is determined and as many sub-buffer handlers as the fragmentation number are generated and stored in step S6.

Subsequently, in step S7, the number of the sub-buffer handlers in the main buffer handler is updated with the fragmentation number.

In step S8, when meta data information of the stored main buffer handler is checked and indicates that a sub-buffer handler exists, the frame is transmitted to an external network interface card, the corresponding sub-buffer handler is deleted, and the number of sub-buffer handlers among the meta data information of the main buffer handler is reduced by one.

Thereafter, when the number of sub-buffer handlers among the meta data information of the main buffer handler becomes zero, transmission of the currently transmitted frame is terminated.

When it has been determined that the data processing method of the frame is the unicast method in step S2, a determination is made as to whether or not a multi-link port is included in the output port list in step S9.

When it has been determined that a multi-link port is included in the output port list (YES) in step S9, the fragmentation number of the frame is determined, and as many sub-buffer handlers as the fragmentation number are generated and stored in step S110.

Subsequently, in step S11, the number of sub-buffer handlers in the main buffer handler is updated with the fragmentation number.

In step S12, when meta data information of the stored main buffer handler is checked and indicates that a sub-buffer handler exists, the frame is transmitted to an external network interface card, the corresponding sub-buffer handler is deleted, and the number of sub-buffer handlers among the meta data information of the main buffer handler is reduced by one.

Thereafter, when the number of sub-buffer handlers among the meta data information of the main buffer handler becomes zero, transmission of the currently transmitted frame is terminated.

When it has been determined that a multi-link port is not included in the output port list (NO) in step S5, the frame is transmitted to an external network interface card in step S13.

In step S14, when the meta data information of the stored main buffer handler is checked and indicates that a sub-buffer handler exists, the corresponding sub-buffer handler is deleted, and the number of sub-buffer handlers among the meta data information of the main buffer handler is reduced by one.

Thereafter, when the number of sub-buffer handlers among the meta data information of the main buffer handler becomes zero, transmission of the currently transmitted frame is terminated.

On the other hand, when it has been determined that a multi-link port is not included in the output port list (NO) in step S9, the frame is transmitted to an external network interface card in step S15.

In step S16, when the meta data information of the stored main buffer handler is checked and indicates that a sub-buffer handler exists, the corresponding sub-buffer handler is deleted, and the number of sub-buffer handlers among the meta data information of the main buffer handler is reduced by one.

Thereafter, when the number of sub-buffer handlers among the meta data information of the main buffer handler becomes zero, transmission of the currently transmitted frame is terminated.

As described above, the apparatus and control method for multicast traffic forwarding in a system supporting PPP multi-link according to the present invention does not directly copy a memory but copies only meta data information with respect to a packet when performing packet copying and packet fragmentation, thereby improving performance of a forwarding engine. Therefore, it is possible to ensure efficient transmission when multicast traffic is transmitted through a multi-link connection.

While the present invention has been described with reference to exemplary embodiments thereof, it will be understood by those skilled in the art that various modifications in form and detail can be made therein without departing from the scope of the present invention as defined by the following claims.

What is claimed is:

1. A multicast traffic forwarding apparatus in a system supporting Point-to-Point Protocol (PPP) multi-link, the apparatus comprising:
a memory adapted to store a received frame and a buffer handler having meta data information; and
a network processor adapted to:
store the frame received from an external network interface card in the memory;
store the buffer handler indicating the frame and as many buffer handlers as either frame copies for multicasting or fragments for multi-linking;
check the buffer handler stored in the memory and then to copy and transmit the corresponding frame stored in the memory via a corresponding port upon transmitting the frame to an external network interface card; and
delete corresponding buffer handlers after transmitting the frame to the external network interface card, thereby managing forwarding of the frame.

2. The multicast traffic forwarding apparatus of claim 1, wherein the network processor comprises:
a reception processing unit adapted to store the received frame and the buffer handler in the memory upon the frame being received from the external network interface card;
a PPP frame forwarding unit adapted to transmit an output port list, after checking a data processing method of the frame received from the reception processing unit;
a packet copying unit adapted to generate as many buffer handlers as output ports corresponding to the output port list and to store the generated buffer handlers in the memory upon receiving the output port list of the frame from the PPP frame forwarding unit;
a multi-link frame fragmentation unit adapted to determine a fragmentation number of the frame, to generate as many buffer handlers as the fragmentation number, and to store the generated buffer handlers in the memory upon receiving a frame header encapsulated in a PPP header from either the PPP frame forwarding unit or the packet copying unit; and
a transmission processing unit adapted to transmit the corresponding frame to the external network interface card after checking the buffer handler stored in the memory.

3. The multicast traffic forwarding apparatus of claim 1, wherein each buffer handler comprises a main buffer handler including meta data information and indicating a buffer address at which the frame is stored, and at least one sub-buffer handler indicating the main buffer handler.

4. The multicast traffic forwarding apparatus of claim 1, wherein the memory is adapted to support PPP multi-link and comprises at least one first buffer handler pool used for a unicast method, and at least one second buffer handler pool used for both multi-linking and a multicast method.

5. The multicast traffic forwarding apparatus of claim 2, wherein the PPP forwarding unit comprises a database having at least one Internet Protocol (IP) address and output port list of the IP address stored therein, the PPP forwarding unit adapted to recognize a data processing method of the frame using a destination IP address stored in the database.

6. The multicast traffic forwarding apparatus of claim 5, wherein the PPP frame forwarding unit is adapted to access the database and to determine whether the data processing method of the frame is a unicast method or a multicast method using the destination IP address.

7. The multicast traffic forwarding apparatus of claim 6, wherein the PPP frame forwarding unit is adapted to access the database and to determine whether an output port of the destination IP address is a general PPP port or a PPP multi-link port.

8. The multicast traffic forwarding apparatus of claim 7, wherein the PPP frame forwarding unit is adapted to encapsulate a header of the frame in a PPP header and to transmit the header to the transmission processing unit upon a determination that the data processing method of the frame is the unicast method and that an output port of the destination IP address is a general PPP port.

9. The multicast traffic forwarding apparatus of claim 7, wherein the PPP frame forwarding unit is adapted to encapsulate a header of the frame in a PPP header and to transmit the header to the multi-link frame fragmentation unit upon a determination that the data processing method of the frame is the unicast method and that an output port of the destination IP address is a multi-link port.

10. The multicast traffic forwarding apparatus of claim 7, wherein the PPP frame forwarding unit is adapted to transmit a header of the frame to the packet copying unit upon a determination that the data processing method of the frame is the multicast method.

11. The multicast traffic forwarding apparatus claim 2, wherein the packet copying unit is adapted to encapsulate and transmit a PPP header to the multi-link frame fragmentation unit upon a determination that an output port to be copied is a PPP multi-link interface.

12. The multicast traffic forwarding apparatus of claim 11, wherein the packet copying unit is adapted to encapsulate and transmit the PPP header to the transmission processing unit upon a determination that the output port to be copied is a general PPP interface.

13. The multicast traffic forwarding apparatus of claim 2, wherein the buffer handlers stored in the memory by the packet copying unit comprise sub-buffer handlers including meta data information indicating the buffer handler stored in the memory by the reception processing unit.

14. The multicast traffic forwarding apparatus of claim 2, wherein the packet copying unit is adapted to update the number of buffer handlers in the buffer handler stored by the reception processing unit with the number of generated buffer handlers.

15. The multicast traffic forwarding apparatus of claim 2, wherein the buffer handlers stored in the memory by the multi-link frame fragmentation unit comprise sub-buffer handlers including meta data information indicating the buffer handler stored in the memory by the reception processing unit.

16. The multicast traffic forwarding apparatus of claim 2, wherein the multi-link frame fragmentation unit is adapted to update the number of buffer handlers in the buffer handler stored by the reception processing unit with the number of generated buffer handlers.

17. The multicast traffic forwarding apparatus of claim 2, wherein the transmission processing unit is adapted to delete corresponding buffer handlers stored in the memory after checking the memory and transmitting the frame to the external network interface card.

18. A multicast traffic forwarding control method in a system supporting Point-to-Point Protocol (PPP) multi-link, the method comprising:
storing a received frame and a main buffer handler upon the frame being received from an external network interface card;
determining a data processing method of the frame;
generating and storing as many sub-buffer handlers of the frame as output ports for the multicasting upon a determination that the data processing method of the frame is a multicast method;
updating the number of sub-buffer handlers in the main buffer handler with the number of sub-buffer handlers;
determining whether or not a multi-link port is included in an output port list;
determining a fragmentation number of the frame, and generating and storing as many sub-buffer handlers as the fragmentation number upon a determination that a multi-link port is included in the output port list;
updating the number of sub-buffer handlers in the main buffer handler with the fragmentation number; and
transmitting the frame to an external network interface card and deleting the sub-buffer handlers.

19. The method of claim 18, further comprising, upon a determination that the data processing method of the frame is a unicast method:
determining whether or not a multi-link port is included in an output port list;
determining a fragmentation number of the frame, and generating and storing as many sub-buffer handlers as the fragmentation number upon a determination that a multi-link port is included in the output port list;
updating the number of sub-buffer handlers in the main buffer handler with the fragmentation number; and
transmitting the frame to an external network interface card and deleting the sub-buffer handlers.

20. The method of claim 19, further comprising, upon a determination that a multi-link port is not included in the output port list:
transmitting the frame to an external network card; and
deleting the stored main buffer handler upon checking the number of sub-buffer handlers and determining that there are no sub-buffer handlers.

21. The method of claim 18, further comprising, upon a determination that a multi-link port is not included in the output port list:
transmitting the frame to an external network card; and
deleting the stored main buffer handler upon checking the number of sub-buffer handlers and determining that there are no sub-buffer handlers.

22. The method of claim 18, wherein the main buffer handler comprises meta data information including the number of sub-buffer handlers and indicates a buffer address at which the frame is stored.

23. The method of claim 18, wherein the sub-buffer handlers indicate the main buffer handler.

24. The method of claim 18, wherein determining a data processing method of the frame comprises accessing a database including at least one Internet Protocol (IP) address and an output port list of the IP address and determining a data processing method of the frame using a destination IP address in the database.

25. The method of claim 18, wherein determining a data processing method of the frame comprises accessing a database and determining whether a data processing method of the frame is a unicast method or multicast method using an output port list of a destination Internet Protocol (IP) address.

26. The method of claim 25, wherein determining a data processing method of the frame comprises accessing the database and determining whether an output port of the destination IP address is a general PPP port or a PPP multi-link port.
